(19) United States
(12) Patent Application Publication
(10) Pub. No.: US 2008/0019496 A1
(43) Pub. Date: Jan. 24, 2008

(54) Method And System For Providing Directory Assistance

(76) Inventor: John Taschereau, Surrey (CA)

Correspondence Address: FASKEN MARTINEAU DUMOULIN, LLP, 2100 - 1075 WEST GEORGIA STREET, VANCOUVER, BC, V6E-3G2, CA

(21) Appl. No.: 11/576,668

(22) PCT Filed: Oct. 4, 2005
(86) PCT No.: PCT/CA05/01512

§ 371 Date: Apr. 4, 2007

Related U.S. Application Data
(60) Provisional application No. 60/614,987, filed on Oct. 4, 2004.
(60) Provisional application No. 60/618,991, filed on Oct. 18, 2004.
(60) Provisional application No. 60/629,349, filed on Nov. 22, 2004.

(30) Foreign Application Priority Data
Mar. 4, 2005 (CA) 2,499,305

(51) Int. Cl. H04M 3/42

(52) U.S. Cl. 379/218.01

(57) ABSTRACT

A method of providing directory assistance from an information provider is provided, comprising: obtaining an utterance including a request for an entity from a requester; passing said utterance through an automated speech recognition system to determine a phone number for said entity; determining if said entity is a subscriber to the information provider; and if said entity is a subscriber, providing said phone number to said requester and connecting said requester to said entity; and if said entity is not a subscriber, providing said phone number to said requester and offering to connect said requester to a subscriber.

### FIELD OF THE INVENTION

This invention relates to systems and methods of providing information to and extracting information from users and devices via voice communications, and more particularly to providing directory assistance without charge to the user.

### BACKGROUND OF THE INVENTION

Automatic Speech Recognition (“ASR”) is commonly used in phone based assistance systems, including directory assistance (“DA”) systems. By automating replies to directory assistance inquiries, such as telephone number inquiries, significant savings can be realized by telecommunications providers and other businesses providing such services.

ASR systems use vocabularies (herein referred to as “grammars”), which represent and define the words an ASR system can “hear”. Grammars are developed and coded on computer systems through means known in the art such as programmatic textual representation, and articulate the words, phrases and sentences which the ASR system listens to (herein referred to as “utterances”) and attempts to match against the grammar to provide a result.

In practice, ASR systems are designed and used to accept utterances, and qualify possible matches within the defined grammar as rapidly as possible to return one or more of the best qualified matches.

Another limitation is the period of time ASR systems require to perform a matching process. As the size of a grammar increases the time required to return a match to an utterance increases.

Additional processing time is required to evaluate the increased number of possibilities. In a directory assistance context, a response has to be delivered quickly.

A further limitation of grammars is that of word order. Grammars are generally defined in a manner which matches an expected word order (for example if the grammar contains “St. Christopher's Hospital”, it will be defined to hear the words “Saint” and “Christopher” in that order). If a given utterance's word order does not significantly match that described in the grammar, a match may not be made or an incorrect match may be generated. In practice, an utterance with a word order which differs from that defined in a grammar can produce a very poor result, especially in cases where other possible matches using the same or similar words exist.

Another limitation is size. Grammars of significant size (over a few thousand entries) represent several implementation and performance issues. Large grammars can be significantly difficult to load into an ASR system and indeed may not load at all, or may not load in sufficient time to provide a useable or natural conversational “dialog” with a user.

It is common practice to split large grammars (which cannot viably operate) into more specific and smaller grammars. In many prior art systems, the user is engaged to provide additional input to direct the system to the appropriate smaller grammar. For example, it is common practice to ask a user “What kind of business would you like to find?” The requestor responds with a business type, for example, “restaurants” and the ASR system proceeds using a smaller grammar of businesses that have been categorized as “restaurants” instead of a larger grammar of all businesses. If necessary this can be repeated, for example by asking “What type of restaurant are you looking for?” While this approach increases accuracy, it diminishes the quality of the interaction and increases costs, as additional dialog with the user is required to provide direction to the ASR system. In practical applications, these additional questions often appear unnatural and diminish the conversational quality desired in ASR systems; increase the overall time associated with obtaining the desired result; and increase the interaction duration, which in turn increases costs.

A further limitation of large grammars is that they are commonly “pre-compiled”. Pre-compiling helps alleviate the run-time size limitation previously noted, however, pre-compiled grammars by nature cannot be dynamically generated in real-time. As a grammar articulates an end result, it is very difficult to implement a large grammar in pre-compiled form which is able to reference dynamic data.

In common practice, the described limitations associated with large grammars limit the practical application of ASR systems in real world solutions. A goal of ASR systems is to minimize the recognition speed required to respond to the user's request. Recognition speed in an ASR system varies depending on several factors, including: (1) grammar size, (2) grammar complexity, (3) desired accuracy, (4) available processor power and (5) quality and character of the input acoustic utterance. Without properly adjusting a grammar of about 10,000 words using ASR adjustments known in the art, it can take 2-3 minutes to recognize a 2-3 word utterance. Many prior art ASR systems have “pruning” abilities to taper and adjust the grammar so that it requires 6-8 seconds to recognize a 2-3 word utterance. This duration can (and frequently does) go as high as 12 to 18 seconds on a fast computer.

In common practice, ASR is applied as a “one shot” process whereby the ASR system is applied “live” while the person is speaking and expected to return a result within a “reasonable” period of time. A reasonable time is that regarded as suitable for conversational purposes, i.e. about 2-3 seconds maximum, and ideally, about 1-2. If this is attempted even with a grammar of only about 10,000 words, the ASR process will likely take too much time. For large cities, the grammars can exceed 250,000 words, which require magnitudes of time where processes will commonly timeout and/or are well beyond what can be considered reasonable.

Most directory assistance programs use a technique commonly known as “store and forward”. These partially automated directory assistance systems prompt the user for answers to questions (i.e. “inputs”), record the answers, and save the answers in temporary storage. Once all of the inputs have been collected from the user, and just before the operator comes online, the inputs are “whispered” to the operator, thereby keeping conversation between the operator and user to a minimum. In such a system the questions are preset, so that the pattern of question/answer will always be the same.

Some directory assistance systems integrate the “store and forward” system with an ASR system. In such an integrated system, the path chosen (by way of the questions asked) varies depending on the answers to the questions. Therefore, when using such a system, the user will not receive a consistent range of questions, as the questions asked depend on his or her answers. When the user answers a question or questions, and the system determines that the ASR system can manage the response, the user is then placed on a voice recognition “track” and asked the questions appropriate for that track (which are generally asked in an attempt to reduce the relevant grammar to a manageable level). These questions are quite different from those asked in the “store and forward” track, so a repeat user can usually quickly determine which track they have been placed on.

A further limitation with ASR systems is that they often have difficulty understanding the utterances provided by the user. ASR systems are set to “hear” an utterance at a specified volume, which may not be appropriate for the situation at hand. For example, a user with a low voice may not be understood properly. Likewise, background noise, such as traffic, can cause difficulties in “hearing” the user's utterances.

ASR systems are now being used to assist in providing directory assistance to users. However, users are charged a fee to use such a service, making them reluctant to use directory assistance unless it is absolutely necessary.

There are also advantages in being able to provide phone users information based on their location. If the location of the phone user is known, then information about the nearest product or service can be provided (for example the cheapest gas station within a certain distance). Furthermore, advertisements can be targeted with precision, i.e. based on where the recipient of the advertisement is likely to be in the near future.

### SUMMARY OF THE INVENTION

The method and processes described herein implement technologies and features for ASR systems that are especially useful in applications where the possible utterances represent a large or very large collection of possibilities (i.e. when a large grammar is required). The method and processes address functional and accuracy problems associated with using ASR systems in general, and in particular, cases where large ASR “grammars” are required. The method and processes described herein are described with respect to telephone directory assistance systems although the process is not limited to such application and can be used in situations wherever voice recognition is used, including mobile phone interfaces, in-vehicle systems, and the like.

A method of providing a listing to a user is provided comprising establishing communications with a user; obtaining a single utterance from said user, and obtaining an answer therefore.

A method of obtaining a request from a device operated by a user, comprising receiving said request as an utterance from said device; processing said utterance; and providing a service to said device in response to said utterance.

A method of providing directory assistance to a user is provided comprising receiving an utterance from a user; determining a listing in response to said utterance; providing an advertisement to said user before providing said listing to said user; wherein said user is not charged an additional fee for the directory assistance.

A method of accessing business information in a personal information manager is provided, comprising the steps of: (a) a user establishing a voice communications link with said personal information manager; and (b) said user accessing a database associated with said personal information manager using natural language.

A method of providing a personal voice directory interface for a user, wherein when an utterance is received and interpreted by an automated speech recognition system as a request to contact an entity, a system examines the user's contact list to determine if said entity is in such contact list, and if not the system performing a directory assistance request to determine the contact information for the requested entity and once the entity is determined, contacting the entity.

A method of providing directory assistance from an information provider is provided, comprising: obtaining an utterance including a request for an entity from a requestor; passing said utterance through an automated speech recognition system to determine a phone number for said entity; determining if said entity is a subscriber to the information provider; and if said entity is a subscriber, providing said phone number to said requestor and connecting said requester to said entity; and if said entity is not a subscriber, providing said phone number to said requestor and offering to connect said requestor to a subscriber. The subscriber may be in the same business class as said entity and may be proximate to said entity. Furthermore, a coupon from the subscriber may be presented to the requestor prior to provision of said phone number.

### BRIEF DESCRIPTION OF THE FIGURES

Further objects, features and advantages of the present invention will become more readily apparent to those skilled in the art from the following description of the invention when taken in conjunction with the accompanying drawings, in which:

FIG. 1 is a flow chart of a latent recognition automated speech recognition system;

FIG. 2 is an overview of a user with a communications device contacting a directory assistance service according to the invention; and

FIGS. 3 through 5 are examples of database listings that might be located prior to the disambiguation process.

### DETAILED DESCRIPTION

In this document, the following terms will have the following meanings:
“automated speech recognition (ASR) system”, also known as a “recognizer”, means a system for matching an audio signal representation (an utterance) to a library of possible libraries and outcomes, typically performed with hidden Markov models and other statistical processing;
“business” means a business or commercial entity or organization that may be represented in a directory;
“directory” means a printed, online, or stored listing of businesses with associated information. For example, a yellow pages phone book, a business listings Internet web site, or a software application storing business listings or communicating with a database of business listings;
“dynamic grammar” means a grammar generated dynamically based on external results or inputs, also known as a latent grammar;
“information source” means a database with means to communicate with a requester, preferably by voice, although other communication means are also applicable;
“grammar” means a representation of audio signals in a defined order; also a codification or representation of possible utterances which will return the appropriate results as coded or represented in the grammar;
“listing” means a representation of a business, individual or government entity in a directory. Listings may be free or paid. Listings typically express the name and contact information. Listings may include additional information and messages.
“natural language” means a methodology to provide a word order concept used in regular speech;
“static pass” means a pass through a grammar used to evaluate broad word usage;
“transparent interface” means a user interaction with an ASR system designed to mimic operator based DA systems; and
“utterance” means a live or recorded audio signal.

The process and system according to the invention address performance problems of accuracy, speed, utterance flexibility, interface expectations, usability, target data flexibility and resource requirements associated with large grammars in ASR systems.

In common practice, a grammar is generated and designed for “single execution”. That is, a grammar is generated knowing that the ASR system will perform a “single pass” on the grammar attempting to match a possible utterance and will return the corresponding candidates. The grammar is generally designed to encompass as many utterances as reasonably possible.

In a preferred embodiment of the invention, the grammar is designed to be as small as possible. Preferably, the grammar is dynamically generated knowing that the ASR system will be used again to perform one or more latent, and optionally concurrent, recognitions, each latent recognition evaluating the terms from a previous recognition process. Such a system is described in PCT Application No. PCT/CA2003/001948 to Taschereau which is hereby incorporated by reference. Alternate grammars could also be used, but may be less effective and result in lower accuracy rates and require longer times to process the utterances.

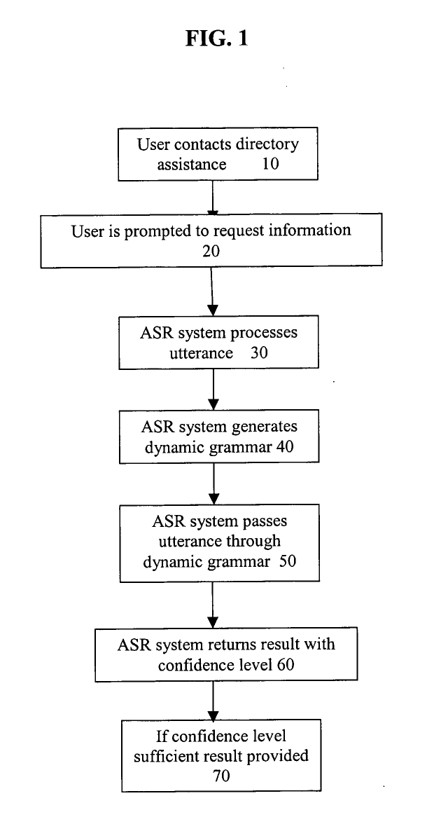

A typical example of a latent recognition process is shown in FIG. 1. A user contacts a service provider, such as a directory assistance number (step 10). The user is prompted to request information, for example by a prompt “what is the name of the listing you are looking for?” The ASR system then uses the recorded utterance to generate a dynamic grammar (steps 30 and 40) and may apply preprocessing to the utterance. The utterance is then passed through the dynamic grammar (step 50) and a result and confidence level is returned (step 60). If the confidence level is sufficiently high (according to predetermined levels), the result is returned to the user (step 70), and if not the user is passed to an operator.

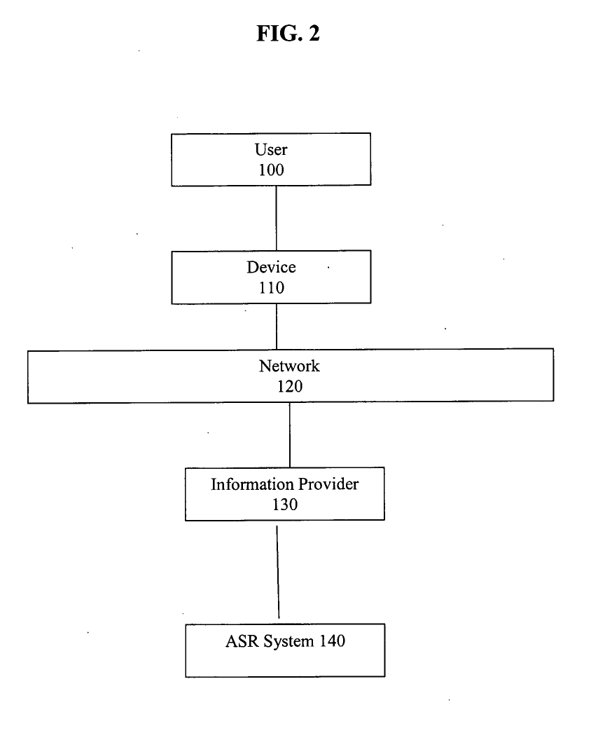

FIG. 2 is a representation of an overview of the system and method according to the invention. Users 100 are operating devices 110 that can transmit an utterance over network 120. Typical devices include telephones (including cellular or mobile phones, and phones used over VoIP or PSTN networks), PDAs, Blackberries, and personal computers. Network 120 may be the Internet, a cellular network or a PSTN. The user contacts an information source 130 which uses an ASR system 140 to process utterances received from the device.

There are several other services an information provider would be able to provide with use of an ASR system. Several of these are described below.

Subscription Symbol

The information provider could use a symbol (such as a trade-mark) that will appear in advertisements for a business, such as print and yellow page advertisements. To contact the business, a user need only contact the directory assistance service and name the business. The call will then be “put through” directly to the sponsoring business.

In this service the symbol may be used by a business to convey to a user that the business sponsors their calls; or that the business can be requested from the service to obtain free call completion or can be located via a business finder service. Typically the right to use the symbol is a paid service.

As an example, a yellow pages directory cover could promotes a service which allows the user to obtain businesses information by a combination of name, type, and/or location. The slogan “Call for Free Directory Assistance” appears and a symbol is associated with the message. Alternatively, a yellow pages directory advertiser may places a symbol in its advertisement.

Free call completion may be provided to users of the information provider, and may be provided only to users asking for a business subscribing to the “symbol”.

Push to Get

The push to get service relies on a user sending an utterance to an information provider. The utterance is processed by an ASR system, and a service is “pushed” back to the device. The type and timing of the information pushed back will depend on the utterance.

For example, the information provided may be invoked by several different inputs determined from the utterance. For example, a time based invocation is possible, wherein the time may be an absolute date and time (such as Nov. 16, 2004 12:05 pm) or a relative date and time (in 1 hour; Tuesday at 5:00 pm). A time may also be a recurring interval (every 5 minutes; every Tuesday at 5:00 pm).

The invocation may also be location based, as a service may be invoked by geographic location. A geographic location may be a GPS position (such as a longitude and latitude), a mobile phone Cell-ID, entering or exiting and a cellular/mobile or wireless network service/coverage area or a specific portion thereof such as interaction with a specific antenna or signal repeater. Alternatively a location reference may be contained in the utterance provided by the device. A location based invocation is based on the interpretation of data that can provide a geographic context or be otherwise construed in a manner to express a geographic point(s), path(s), or other arbitrary area(s).

A service may also have an event based invocation, such as the reception of a Bluetooth, SMS, Infrared or other communicated message or other events such as an automotive airbag deployment, an online sale, or GPS geo-fencing event.

The utterance sent to the information provider will contain a request. The request may be explicit, such as “Show me the restaurants near me” or simply “restaurants”. Alternatively, the request may be implied. For example, one or more changes in geographic location could be construed as a request for traffic information. A request may be associated with the nature or purpose of the service, such as a “Traffic Service” which provides traffic information or a “Buddy Finder Service” which provides Instant Messaging service “Buddy” information.

The request must be communicated to the information provider. The request and any additional required or desired data to satisfy the request (“additional information”) is communicated to a processing facility (such as an ASR system) via a communications network. A communications method is selected prior to the communication and may be device dependent.

The request and any additional required or desired data may be communicated to a processing facility in real time, such as via a voice call using a network. The network may be a mobile, circuit switched, packet switched or any combination of these. Such transmissions would typically take place on a “voice channel” or other “voice network” facility. It is possible to conduct such a transmission on a “data network” facility, such as by using a VoIP (Voice over Internet Protocol) such as H.323 or SIP or other means of real or near-real time communications.

Alternatively, the request and any additional information may be communicated to a processing facility in non real time. Such transmissions would typically take place on a “data channel” or other “data network” facility. If deferred communication is used, the request and additional information should be obtained prior to communicating the request and additional information.

For example, any user speech should be recorded prior to communication of the request and additional information to the processing facility.

The communication method may be determined by various factors including, but not limited to, the capabilities of the device, the availability of various communications networks in general and to the user specifically, user preference, class of service or service priority, the nature of the service itself, and other factors. Both real and deferred communications may be used simultaneously. This capability is typically device dependent.

The request and additional information is communicated to the processing facility. The processing facility receives the request and additional information and processes the request and additional information. The processing facility then acts on and/or replies to the request and additional information.

The method therefore provides information to one or more parties from a device is provided. In most cases, an audio recording is submitted to a device which embodies some or all of a request for processing and/or some or all of the additional information which may be needed to satisfy the request. The device may be a cellular phone, a PDA, a Blackberry, a telephone (connected via VoIP or PSTN), or any other device capable of storing or transmitting an utterance and receiving information.

In most cases, automatic speech recognition (ASR) is used to interpret the request. In this process, the ASR implementation may be part of a larger processing facility. This reduces the need for discrete ASR resources on the device and allows for greater economies of scale and better resource application by consolidating said resources in a central facility. A key feature of this approach is that no specific phone call requesting information need be made by the user.

The process described herein provides for speaker independent and untrained speech recognition services to appear as if available on the device. In common practice, for certain devices such as mobile phones, limited speech recognition is available. Such speech recognition, however, requires training and is limited in scope. Typical implementation of such speech recognition is usually for voice activated dialing wherein the user records the name and assigns the recording to a given contact in the phone's directory of contacts.

The process according to the invention allows for much more powerful implementation of speech recognition seemingly present on the device and without the requirement to make a typical phone call to a service providing speech recognition.

The process represents a form of communication which is “sessionless” in the normal context of communications. Typically packet and circuit switch networks use protocols to construct a “session” for which a disruption typically “breaks the session” and terminates the connection. The process described herein instead uses one or more discrete communications—conceptually discrete and distinct sessions—for the purpose of representing a larger context of “session”. This reduces the resources requirements associated with communications.

Obtain Audio Recording

A step in the push to get method is to obtain an audio recording. The audio recording may be of speech, but may be of other non-speech audio such as music, machinery operating, etc. The audio recording represents content which is salient to the service or application. The audio source for the audio recording may come from one or more sources (typically from the user of the service) depending on the purpose of the service or application, alternatively, the audio recording may be provided by other related or unrelated processes.

For example a digital recording of music could be used as the audio recording. As another example, a conversation recorded on a mobile phone using a conversation recording facility could be used.

Audio Recording Pre-Processing

Optional processing of the audio recording may be desirable or required.

Typically, the various capabilities and properties of the device, the transmission facility and the service of application will determine what processing can or should be done prior to transmission and what can be done after transmission.

In the case of speech, it may be desirable to perform certain modifications to the audio recording. Such modifications may include, but are not limited to, removing leading and trailing silence or noise before the actual speech portion of the signal content, normalization of the audio recording, and gain adjustment. Pre-processing is not limited to the modification of the audio recording and may include extraction of information about the audio recording or the content it represents.

Audio Recording Conversion

The term CODEC refers to technology used for the compression and/or decompression of data. A CODEC temporarily or permanently reduces the amount of data needed to represent a reproduction of the original data. Such reproduction may vary in accuracy depending on the CODEC used for the compression of audio and video data, as each have their particular benefits and side effects. A CODEC may result in the data being output in a format.

In the telecommunications field, the term CODEC can also refer to the process of encoding and/or decoding signals for transmission on disparate facilities, for example, the conversion of binary data into a voltage that can be transmitted across a wire.

The term format (also “file format”) means a method of encoding information and defines how the information is represented and organized. Virtually every kind of meaningful encoding of data relies on a format in order to be useful. Numerous standard formats exist or have otherwise emerged for various content. For example, the WAVform audio format, commonly called WAV is a standard for representing audio on many computing and personal devices, in part due to the fact it supports the representation of audio compressed with any CODEC.

In a preferred embodiment, consideration of the CODEC and format are required. The consideration is based on the capabilities of the device, the properties of the transmission facility and the capabilities of the service or application. The audio recoding may be re-encoded using a particular CODEC and format. Such consideration is largely an attempt to determine a CODEC and/or format which can most effectively reduce the amount of data (thus reducing transmission time and/or cost) while maintaining the ability for the audio recording to be useful within the context of the service or application. Such consideration should also ensure the CODEC and format can be handled by the service or application. It may be required that the service or application perform necessary conversions to support other processes which may rely on the audio recording.

In a preferred embodiment, in the case where the audio recording is of a speech utterance and is intended for processing, the adaptive multi-rate (AMR) CODEC is typically preferred. The AMR CODEC is capable of representing speech audio signals in a very efficient manner thereby reducing the amount of data needed for transmission.

AMR is a “lossy” compression method and some data representing the audio signal in the audio recording will be permanently lost. Some ASR systems may not directly support audio in AMR format in which case conversion to another CODEC and format may be required. Some ASR systems may not function properly even after the conversions due to the permanently lost data.

Audio Recording Transmission

The audio recording is then transmitted to a processing facility. The method of transmission of the audio recording to the processing facility may involve any of several different methods. In the preferred embodiment, the method of transmission takes into consideration the capabilities of the device, the properties of the transmission facility including cost and availability, and the capabilities of the processing facility to receive the transmitted audio recording via various different transmission methods.

For example, multi media messaging (MMS) may be the preferred transmission method in some cases such as when the device does not have the capability for an Internet connection or the device does not have Internet services available (for subscription, geographic or other reasons).

As another example, HTTP POST or another custom Internet protocol may be the preferred transmission method in cases where the device is capable of transmitting data via an Internet connection and said capability is available.

It may be required that the audio recording be “broken” into “parts” depending on the transmission method. For example, short message service (SMS) transmissions are very limited in size and may require the audio recording to be broken into suitably sized parts and transmitted as a series of smaller discrete transmissions.

Additional Information Transmission

Additional information may be transmitted to the processing facility. Such additional information may or may not be required to satisfy the purpose or function of the service or application. Additional information may be transmitted in similar form to the transmission of audio recording (via appropriate methods such as SMS, MMS, HTTP POST, custom protocol, etc).

Additional information may or may not be transmitted in the same transmission as the audio recording and may take place independently and more often as required by the service or application.

Some additional information may be required to identify the user, for example, the application name, version, subscription data, etc. Some additional information may be required to establish the concept of a “session” depending on the service or application and how the said service or application is interacted with.

As an example, if an audio recording was transmitted and processed by the processing facility which embodied the request for a map (e.g. for a request “Map of downtown Vancouver”) and a subsequent audio recording embodied the request for an adjusted view of said map (e.g. “Move north” or “larger”), the additional information might contain data sufficient to convey the nature of the map at the time of the second request or might contain data sufficient for the service or application to relate the first and second request.

Some additional information may be required for communication device properties and capabilities. Such properties and capability might include display capabilities and resolutions (size of display and number of colours), information about the audio recording format, and other technical requirements.

Some additional information may be required to communication user preferences. Such user preferences may include the desired method of transmission of the response from the service or application.

An example of additional information which may be required to augment the audio recording could be a global positioning system (GPS) position or a network operator's identification and the cell ID the device is operating with. In this case, the audio recording could include the speech representation for “near me” and a service and application could construe that the GPS position or cell ID represents a geographic location or area to be used to satisfy the purpose of the service or application.

In a preferred embodiment, the additional information required to satisfy a request should be sent if it has not already been sent or should be resent if the additional information was previously sent but may have expired in terms of its usefulness. An example would be a case where a GPS position was previously communicated but the probability of the user's movement is sufficiently high that the earlier GPS position is likely no longer valid for the purposes of the service or application.

Processing Facility

The audio recording and additional information is received via the transmission facility. Any audio recording or additional information re-assembly required due to the transmission process should be performed. Any conversions or modifications of the audio or additional information required to support other subsystems or processes within the service or application should be performed.

For example, if the audio recording represents speech audio in the AMR format, and an ASR system must be used for the purposes of the service or application, and said ASR system does or cannot accept the audio recording in the AMR format, the audio recording should be converted to a suitable format.

Additional information should be received and processed as salient to the service or application. Such processing includes the authentication of the audio recording and additional information is performed to ensure the audio recording and the additional information is from a valid sender and user of the service or application.

Processing

Typically, the service or application will use ASR to process the audio recording although this may not be a requirement depending on the service or application. An example of ASR usage would be the case where the audio recording contains a request to be processed by a machine first and possibly by human intervention, such as “Where is ACME Widgets?” or “Send the contract to John Doe”. In these cases, automated systems may process and satisfy the request as part of the service or application.

Non ASR usage would be where the audio recording will not be processed by a machine, either because the content of the audio recording is not intended or does not pass through an ASR system and/or because the additional information contains information which provides the required information to process the audio recording as part of the service or application. An example of such usage would be where the audio recording is to be relayed to (an)other party(ies) and the service or application is fixed or the additional information contains the delivery list.

The service or application processes the audio recording and/or additional information as required in accordance with the service or application.

In the preferred embodiment, the context of “session” may need to be construed. For example, in a typical telephone call using circuit switched networks, the caller and callee converse in the context of a “session”. The “session” is the act of establishing and maintaining the conversation for said conversation. This is true for Voice-Over-Internet (VoIP) calls as well. While the network itself is fundamentally different (packet switched as opposed to circuit switched), the supporting protocols create “sessions”. When these protocols “close” or are otherwise interrupted, the “session” generally ends.

In the context of the present invention, the notion of context is not present. In other words, several audio recordings and additional information may be sent as pare of an “overall conversation” or “usage” of the application or service.

Different concepts may be used to determine or defined the concept of “session” in this case of this invention. The appropriate method or methods are related to the desired human and machine interface requirements and the purpose of service or application.

In a preferred embodiment, several key elements can be used and, if appropriate, sent as part of the additional information.

For example, if between requests for a map service or application, the device application was terminated and restarted, this could be conveyed to the processing facility and any previous sessions cleared. In other words, it is like saying “I'm not working on the previous requests any longer and this audio recording should be considered and evaluated in the context of a new request or instance of service”.

In a preferred embodiment, a time limit is generally applied to automatically age and expire requests. For example, after 20 minutes any new audio recording and/or additional information should be considered a new request or instance of service; the audio recording and/or additional information should not be interpreted or processed as part of a previous request. This facility for sessions allows for discrete and distinct interactions to be processed as an overall request.

Results

The results of the service or application may encompass one or more different responses depending on the purpose of the service or application. The result may include audio or visual data to be communicate to the originator of the request or to (an)other party(ies). For example, the request for “a map near me” might result in a visual map being transmitted to the requesting party.

The result may include actions. For example, a request to “Turn on the lights” may result in an X-10 command issued over wiring resulting in the illumination of lighting.

In a preferred embodiment, the method of communicating any results may be expressed in the additional information transmitted to the processing facility. The method of communication any results may also be fixed or inherent in the service or application.

The method of communicating any results may also be implied by the transmission method used to send the audio recording and/or the additional information. For example, an MMS used to send the audio recording and/or additional information could indicate the preference for communicating any results be via MMS as well.

In a preferred embodiment, the user/device functionality is invoked with minimal effort, for example a single key-press, although the actual invocation of the functionality may be implemented in any manner appropriate or preferred.

As an example, an application may be invoked on a mobile phone by pressing and holding a specific key. The key may be assigned by the user as a preference. Furthering the example, pressing and briefly holding the “4” key may commence the process. The process is this case may be to request contact information. Different services or applications may be represented and invoked by assigning different key-presses.

As an example, an application on the same mobile phone as described in the immediately prior example, may have assigned a different service, such as obtaining work order information, to the “5” key. In this case the process of requesting work order information is obtained by pressing and briefly holding the “5” key.

Different services or applications may not require invocation but instead support automatic pushing. For example, a traffic application may send additional information including the location information of the device (either expressed as a Cell ID or a GPS or Assistance GPS location). This additional information may be sent on a recurring basis, based on time, distance or other salient criteria. When the service or application has determined that the user is moving in a particular direction for which traffic information is available and would be of interest, said traffic information may be sent to the device and/or (an)other party(ies).

Multiple services and applications may be embodied in a single device application. In this case the user interface may vary and menus or other methods of selecting the specifically desired service or application may be required. The service or application may determine the specific service or application based on the content of the audio recording or additional information. For example, a single application on the device may be invoked by pressing a single key, and a menu solicits the user to select a specific service or application.

Alternatively, the processing facility may determine the proper service or application by evaluating the content of the audio recording. For example, by examining the audio recording for specific keywords which imply or explicitly state the service (e.g. “work order for . . . ” or “contact information for . . . ”).

Traffic Service Example

John Smith uses a mobile phone. An application called “Traffic” resides on the device. When running the Traffic application on the device, the device obtains the location information from a GPS or Assisted GPS device which may or may not be part of the phone itself. Alternatively, the location information may be the current Cell ID of the network operator providing service to the phone.

The location information is obtained at regular intervals and/or other events (such as the GPS reporting movement). The Traffic application evaluates the location information and, based on a combination of user preference and application logic, determines if the location information should be sent to the processing facility. If so, it is sent as additional information.

In the morning, John Smith is at home. His location is not changing significantly. As such, there may be few additional information reports to the processing facility.

John Smith gets in his car and starts to drive. The Traffic application notes that the location has changed and transmits the location as additional information.

The processing facility receives the location additional information. A service or application examines the location information being communicated and, based on various criteria (such as time of day and previous location samples), calculates that John Smith is likely driving to work. The processing facility obtains traffic information and determines that there are traffic problems associated with the locations John Smith is typically driving through.

The processing facility then sends John Smith several maps which show the areas where traffic problems are present and provides an alternative.

In this example, the user did not provide any audio recording. The Traffic application obtained results without the user specifically asking for information at the time the information was needed.

Non-Trained Voice Dialing Example

Mary has a mobile phone. Her phone contains contact information stored in a database on the phone. Mary uses a Contact Dialer application on her phone. The application periodically sends the contact information stored in the phones to the processing facility as additional information.

Mary presses and briefly holds the “5” key on the phone which she has assigned the Contact Dialer request process. The Contact Dialer asks, “For what name place?” which can be heard as a recording emanating from the phone.

Mary responds with “Call David at home”. The speech is recorded as an audio recording. Any required salient pre-processing and conversion is performed. In this example, the audio is cropped and the AMR codec and format are used. The audio recording is transmitted to the processing facility. Additional information indicating this is a request from the “Contact Dialer” application is transmitted. In this example the audio recording and additional information are send as a HTTP POST via a GRPS connection.

The processing facility receives the audio recording and additional information. The additional information indicates that the audio recording should be interpreted as a Contact Dialer request. An ASR grammar representing the contacts information previously uploaded is used as an ASR process. The result is the directive to call David at home.

The reply consists of information which, when received by the phone, invokes the phone's dialing facilities thereby causing David to be called at home.

In this example, contact information in the phone was used to facilitate a speech recognition process and, ultimately, a dialing process on the phone.

Personal Portal Example

In a personal portal integrated with a directory service, as shown in the previous example, the system reacts to the voice instructions of the requestor and of preferences previously provided by the requester.

For example the system may prompt the requestor with “What would you like to do?”. On receipt of instructions to “Call Mark”, the system looks for Mark in the requestor's personal contacts, finds the listing and calls.

Alternatively, when the system prompts “What would you like to do?” and receives instructions to “Call Dominoes”, the system then looks for Dominoes in personal contacts and fails to locate a listing. The system then checks directory assistance using the requestor's preferences, finds the listing and calls.

In an alternative response, the system prompts “What would you like to do?” and receives instructions to “Call Rogers Video”. The system then looks for Rogers in the requestor's personal contacts and fails to locate a listing. The system then checks the requestor's directory assistance preferences and fails to locate a listing. Finally the system checks the directory assistance service, finds a listing and completes the call.

The use of a personal portal with personal contacts and directory assistance preferences allows for increased efficiency for frequently called numbers. The system stores calling preferences to profile the user's commerce habits and expectations. These can be entered by the user or the system can track the users preferences, for example by telephone numbers called and/or speech verification services which can accurately distinguish a caller using different phone lines.

The preferences can be used for a variety of purposes, including direct marketing or marketing to specific areas of interest. The information can be used within the system to enhance the user's experience. For example, when a profiled caller requests “a men's clothing” store, the system could determine that he has made calls to Hugo Boss outlets, etc. thereby qualifying the kind of clothing shops the requestor would be interested in.

The system is preferably capable of self learning preferences. Frequently requested listings by a caller can be “promoted” internally within the system for aggregate requestor and specific requestor use and to promote recognition accuracy and improve the user experience. As each listing is returned by the system, a value is incremented internally. The value may be used to express promotion of the listing in terms of it relative weight to others on a user specific or a wide scale (more than one user or variations in market, etc.). In the preferred embodiment, the system becomes faster and more adept at recognizing specific listings on both a specific caller basis and broader.

Information from directory assistance can be sent to users, either to compatible devices such mobile phones, email programs, etc. or to applications such as the user's personal portal. In the preferred embodiment, the user can provide preferences specifying their email information and web site and contact information can be sent via “v-Card” or other format to the user.

Both businesses and users (also known as requestors) can use a personal portal which provides email, contacts, calendar, voicemail and document services accessible via voice and other input modes, such as a keyboard. The personal portal preferably includes services and functionality targeted towards businesses or users.

For example, Personal Portal for consumers could include voice activated personal contacts, email, calendar, voicemail and documents. These would be managed by web and custom applications. For example, if John had a personal portal and it had a specific phone number, he could give out his Personal Portal phone number instead of his cellular phone. Using the management facilities on the personal portal (via web, voice, specific computer applications, PDA, etc.) he can set the portal such that calls from Kathy should be forwarded immediately to his cellular phone, however, he can specify that calls from David should simply disconnect or play a not-in-service message while all other calls should go directly to voice mail.

For businesses, personal portal may include an automatic attendant and a more business specific call forwarding service. For example, a call to ABC Co. (a personal portal equipped number) may be set to make Mr. A's home office phone ring and/or Mr. B's cellular phone ring.

Alternatively, if the call is not answered within three rings, the system makes Mr. C's home phone ring. Failing an answer, the call may go to voice mail.

Entities representing the various phone numbers (businesses, residences) provided by the system may use the web to define their preferences for providing listings (as mentioned above such as call forwarding/follow me, etc.), hours of operation, etc.

Voice Mail Example

Bob has defined his preferences such that voice messages from particular individuals notify his cell phone (via SMS, MMS or other format). In a preferred embodiment, the preferences may include provisions for the transferring of audio to the device and the device's either spontaneous playing pf the message or providing an option for the user to hear the message.

Calls from Larry, Mary and Doug may go to a voice mail facility, as normal. However, calls from Mary result in Bob's phone beeping and an alert prompting him to hear the message. If yes, the message has either been already sent to the phone or may be requested as a result of the alert response. Bob hears the message without calling his voice mail service.

Calls for Larry, Bob's boss, are immediately “broadcast” in a manner similar to push to talk or 10-4 systems. Calls from Doug do not notify Bob's phone.

Disambiguation

One difficulty with ASR systems in a DA context is that there are often several listings with common features. For example there may be several listings for a chain restaurant or retail outlet in a particular geographic area. Likewise large offices may have several listings at a single address for different departments, for example the sales and human resources departments may have different listings. Even a small business may have different numbers for phone and fax lines.

Interactive Disambiguation

An operator in a live directory assistance environment generally performs two main functions to service an inquiry: (1) the interpretation of an inquiry as expressed by the caller in an utterance and the translation of that inquiry into suitable search criteria to be targeted against a database; and (2) an interactive selection process to refine the set of possible results to the particular result to satisfy the inquiry. One way of accomplishing this second task while using an ASR system is to provide the requestor a list of matching results and to ask the requester to further refine the question. This process is herein referred to as “presentation resolution”.

The objective of presentation resolution is to determine and present the precise information requested by resolving any ambiguities impeding the successful conclusion of the request. The objective is to make the process as clear, simple and concise an experience as possible such that the requestor will not have complaints and that obtains the desired result as easily and quickly as possible. The process is similar to that of an operator's approach but takes full advantage of an ASR system's ability to process large amounts of information quickly.

Users of directory assistance often do not use full, proper, complete, or even accurate terms when making a request. As the results obtained by the ASR system may reflect more than a single listing meeting the criteria from the user, the name resolution process qualifies the inquiry. In such a case, the user must identify which one of several listings is desired. The approach uses characteristics from the returned listings to assist the user in making a determination.

The target listing of a directory assistance inquiry as expressed by the user may share similar words or even the entire name as other listings in the grammar. When this occurs the ASR system returns multiple (and therefore ambiguous) results. Preferably, the name presentation process initially presents all of the matched listings.

Some examples of the name presentation process (from the perspective of a user requesting the listing) follow.

### EXAMPLE 1

| | |
|---|---|
| User: | “Wood Gundy” |
| ASR | “I found several businesses with similar sounding names, |
| System: | CIBC Wood Gundy Investments and CIBC Wood Gundy |
| | Securities. Which one would you like?” |

### EXAMPLE 2

| | |
|---|---|
| User: | “Budget Car” |
| ASR | “I found several businesses with similar sounding names: |
| System: | Budget Car & Truck Rental, Budget Car Sales, and Budget Rent |
| | a Car & Truck. Which one would you like?” |

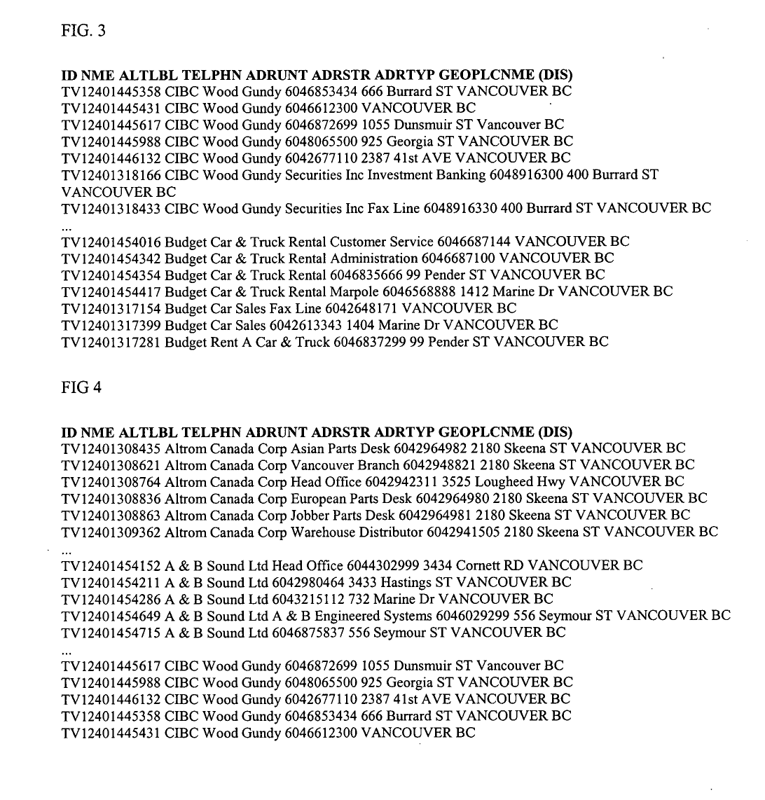

The listings returned by the ASR system for the above examples are illustrated in FIG. 3.

As seen in FIG. 3, although “Budget Car & Truck Rental” and “Budget Rent a Car & Truck” represent the same logical entity (they have the same phone address), the ASR system typically does not make any assumptions and presents both names. These references are typically provided in the source data used to develop the listing database.

To carry out this process the ASR system uses the listings or a list of words and a location reference (such as an address, region or cross street), and obtains all of the distinct names represented by the listings or word list and returns a data structure indicating: the presentation form (i.e. “name”), the number of distinct names being returned, and an ordered array of presentation and grammar information facilitating the presentation and selection of a particular item within the array.

Frequently listings with the same name in a particular jurisdiction (for example a Canadian province or a U.S. state) can be assumed to represent different locations of the same entity as the applicable corporate law typically disallows different companies in the same jurisdiction to use the same name.

Alternatively, the listings can be presented to a user based on their location and in the proper order and form associated with a particular named entity.

### EXAMPLE 3

| | |
|---|---|
| User: | “Altrom Canada Corp.” |
| ASR | “I found several locations: the Head Office, and the Skeena |
| System: | Street location. Which one would you like?” |

### EXAMPLE 4

| | |
|---|---|
| User: | “A & B Sound” |
| ASR | “I found several locations: Head Office, A&B Engineered |
| System: | Systems, a Hastings Street location, and a Marine Drive |
| | location. Which one would you like?” |

### EXAMPLE 5

| | |
|---|---|
| User: | “CIBC Wood Gundy” |
| ASR | “I found several locations: a Main location, a 41st Avenue |
| System: | location, a Burrard Street location, a Dunsmuir Street |
| | location, and a Georgia Street location. |
| | Which one would you like? |

Example 6 below illustrates a response in which the location which does not specify a particular address.

### EXAMPLE 6

| | |
|---|---|
| User: | “White Spot” |
| ASR | “I found several locations: Georgia and Cardero, and Georgia |
| System: | and Seymour. Which one would you like?” |

See FIG. 4 for examples of the records in the database located by the ASR system in Examples 3 through 6.

The ASR system obtains all of the listings in the database which share the same Name (in the field nme in the Figures), but have different address fields (found in the fields adrunt, adrstr, adrtyp, adrdirpre, and adrdirsuf in the Figures) in the same geographic place (e.g. a city) and optionally on the same given street and street type; and returns a data structure indicating: the presentation form (i.e. the “location”), the number of discrete locations obtained, and an ordered array of presentation and grammar information.

Locations are identified by either the alternate label field (the field labeled altlbl in the Figures) or, if empty, the street and street type. In the event multiple locations appear on the same street, only a single presentation will be made. In the event that a street constraint is provided and more than one location is identified, cross streets may be used as part of the presentation if the alternate label fields are not available.

Listing Presentation

The target entity requested by a directory assistance inquiry may be represented by one or more listings in the database. Listing presentation is concerned with presenting all of the appropriate numbers, in the proper order and form, associated with a given target entity.

Listing presentation includes two major processes which are abstracted along functional lines: (1) obtaining the target entity's related listings; and (2) presenting the entity's related listings to the user to facilitate the user's obtaining the particular information from a particular listing.

### EXAMPLE 7

| | |
|---|---|
| User: | “Abiance Florals Example” |
| ASR | “I have several numbers for that location: the main number, |
| System: | and the fax number. Which one would you like?” |

### EXAMPLE 8

| | |
|---|---|
| User: | “Peace Arch News” |
| ASR | “I have several numbers for that location: the office |
| System: | number, and the classified number. Which one would you like?” |

Given an object reference as an Object ID, the function obtains all of the objects in the database which share the same name (field nme), geographic and address fields (adrunt, adrstr, adrtyp, adrdirpre, adrdirsuf, and appropriate geo fields) and returns a data structure indicating: the presentation form (“listing”), the number of discrete listings obtained, and an ordered array of presentation and grammar information.

### EXAMPLE 9

| | |
|---|---|
| User: | “Able Copiers” |
| ASR | “I have several numbers for that location: the fax number, |
| System: | and an alternate fax number. Which one would you like?” |

### EXAMPLE 10

| | |
|---|---|
| User: | “Air New Zealand” |
| ASR | “I have several numbers for that location: the district |
| System: | sales office, and the fax number. Which one would you like?” |

### EXAMPLE 11

| | |
|---|---|
| User: | “Altrom Canada Corp. (Skeena Street Location)” |
| ASR | “I have several numbers for that location: the Asian |
| System: | Parts Desk, the Vancouver Branch, the European Parts |
| | Desk, the Jobber Parts Desk, and the Warehouse |
| | Distributor number. Which one would you like?” |

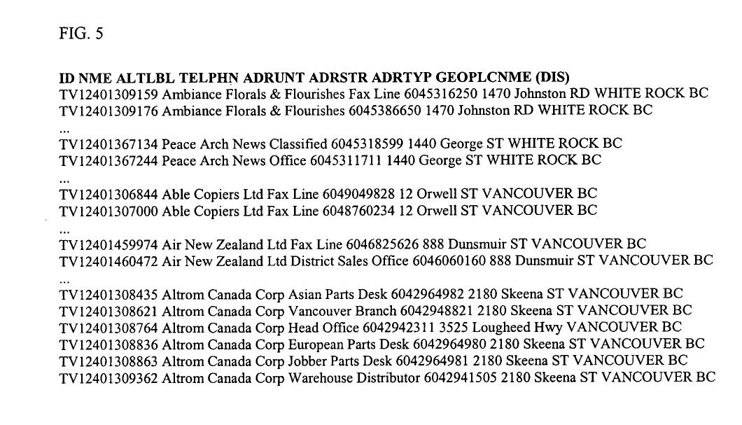

See FIG. 5 for examples of the records in the database located by the ASR system in Examples 7 through 11.

Presentation and grammar information is preferably ordered according to the following rules:
1. Items whose alternate label (altlbl) field contains “Fax Line” are placed at the end of the structure (and are accordingly presented last to the user).
2. The following criteria identify which item(s) are placed at the top of the list:
   a. Where only one returned object contains “Head Office” in the alternate label field, this item is placed at the top of the list.
   b. Where only one returned object contains nothing in the alternate label field, this item is considered the “main number” or “primary listing” and is placed at the top of the list.
   3. If two or more objects contain the same alternate label, the second and subsequent items are referred to equally as “alternate”.

The above system allows for flexible presentation to the user to help ensure the correct response is obtained.

There are many other ways of ordering the returned objects for presentation to the user. For example, in an alternative embodiment, listings are returned to the user based on the amount paid by the business to the DA service provider. This feature is also useful when the user is not looking for a specific listing, but a “type”, for example a “Greek restaurant” in or around a certain location.

Geographic References

The system and method according to the invention can also serve to direct services to users or direct users to services. For example when a user requests the phone number of a taxi company, it is likely that user is actually trying to have a taxi sent to a particular location. The ASR system can be used with geographic recognition to provide this service. The system and method can be modified to ask the user if they are looking for a service, e.g. a taxi, or the nearest hotel, and if so, they can be asked to give their location. Then after determining the location of the user they can be directed to the nearest hotel, or the closest taxi can be directed to them. This feature can be used with a number of services, including restaurants, pizza delivery, laundromats, etc.

Geographic referencing can also be used to provide answers when the user gives incorrect information. For example, if the user asks for a listing that doesn't exist in a particular location, the system can look in neighbouring areas (for example a suburb) to determine if the appropriate listing is actually there. Also areas that have very similar sounds may be checked. For example if a reference can't be located in the town named “Oshawa”, the ASR system, time permitting can, then check the location “Ottawa”.

In a preferred embodiment the system and method according to the invention will use the method described in PCT Application No. PCT/CA01/00689 to Taschereau, which is hereby incorporated by reference.

Self-Learning

It is common in the prior art to “train” an ASR system to recognize an individual user's utterances (as is commonly done with dictation programs). The system described herein preferably also incorporates a self learning system. An advantage to the present system is that if the ASR process fails to arrive at the correct response, eventually an operator will handle the call and determine the “correct” answer (perhaps by obtaining more information from the user). In such a case the operator can also provide the correct answer to the ASR system, which can modify itself to “learn” from its mistake. This can allow the ASR system to “learn” regional dialects, accents, and unusual (but perhaps locally common) pronunciations.

Business Process

In the prior art, the traditional model of providing directory assistance services via telephone has been to charge users directly, typically at a fixed fee for each request made to directory assistance. By using the system described above a higher success rate of automation can be provided, which will reduce the costs of offering directory assistance. As the cost is reduced, a business case can be made for providing directory assistance to users at no cost, by using advertising to allow a business to provide the service.

There are several opportunities for advertisements to be presented to a user during the automation process as described above. When the phone is answered, an advertisement could be presented, for example “This service has been brought to you by company XYZ”. Another opportunity for advertising is available just before the number is provided to the user. Yet another opportunity for advertising is when the user is waiting during the ASR system's processing of the utterance, and if the answer is being provided with visual information (such as via an MMS message to a cellular phone), there is yet another opportunity for an advertisement.

The making of a request for a business also provides an opportunity to target an advertisement. For example when a request is made for a restaurant in a certain geographic area, a competitor could present an advertisement with an inducement (e.g. a coupon or the like) in an attempt to lure that customer to a different establishment. The user will also be providing information about themselves (at least based on the area from which they are calling and the call display information—perhaps more if a location reference is obtained). By using the information available about the user and the listing the user is looking for, very precise targeted advertisements can be presented to the user.

By selling this targeted advertising, it is possible for a service provider to provide directory assistance at a profit without charging users of the service for the calls. Given that the cost of the calls is a major constraint on the use of directory assistance services, by removing this cost, the demand for directory assistance will increase. The targeted advertisements may be sold to businesses at a cost per presentation of an advertisement, a cost for a number of presentations, or a cost per successful connection between a requester and the business.

An alternative method of providing directory service is to provide a non-advertising based model that can be applied to all businesses easily and without effort, i.e. no production of advertisements, and a simple business relationship. This system is based on business purchasing memberships or participation (for example by paying a monthly fee) in which case the directory assistance system will connect callers to the business. If a business does not participate, they risk their competitors participating, as the directory assistance system will offer to connect the user to a participating business in the same class (i.e. that provides the same services), and the non-participating business may thereby lose customers. This method may or may not be used in conjunction with a paid advertising model.

In this embodiment a directory assistance call would be placed to a free directory assistance service. The “on-hold” time presents an advertisement as the ASR system determines the listing. When the listing is being provided, the system also offers to either connect the user to the business (if the business participates), or to another entity in the same business class who is participating if the target business is not participating.

### EXAMPLE 12

| | |
|---|---|
| User: | “GiGi's Pizza.” |
| DA | “The number is 604 555 1212. Stay on the line and |
| System: | we'll connect you to GiGi's Pizza who will be happy to |
| | take your call.” |

This example shows events that could take place in the case that GiGi's Pizza is a participating business. If it is not, the sequence may proceed as follows:

### EXAMPLE 13

| | |
|---|---|
| User: | GiGi's Pizza. |
| DA | “The number is 604 555 1212. Stay on the line and |
| System: | we'll connect you to Franco's Pizza who will be happy to |
| | take your call.” |

Therefore, in a preferred embodiment, requestors ask for the listings they desire and immediately prior to providing the requested phone number, a sponsor is presented to the requestor.

If the business being asked for by the requestor is sponsoring their calls (i.e. paying a subscription fee or the like to a provider), it is identified to the requestor. The requested information is then provided. The call from the requestor is ideally connected to the party represented by the requested listing.

If the business being asked for by the requestor is not sponsoring calls, a sponsor is selected. Ideally the sponsor is a local, competitive or associated business which is sponsoring their own calls. The sponsor is identified to the requestor. The requested information is provided.

Ideally, the requestor is given the opportunity to have their call connected to the sponsor. In some circumstances, a choice may be offered to the requestor to connect to the sponsor or to the requested listing. In some circumstances, the call may be connected to the requested listing.

The service is preferably provided free to customers. The service undertakes the costs associated with providing the service. Businesses are invited to share in the cost of providing the service to consumers by sponsoring their own calls. Participating businesses are charged a fee.

Businesses may also sponsor calls for other businesses. Other businesses may be selected specifically or by classification. Participating business are charged a fee or this aspect of the offering is bundled with call sponsoring.

Businesses may purchase a “buy line”, a promotional message which is presented to callers when they are sponsoring calls. Businesses are charged a fee for provision of this message. Buy lines have virtually no production costs and are typically presented as text to speech (TTS) although professional produced audio could also be used. Preferably a web interface may be used to allow businesses to provide advertisements for the system.

The service creates a competitive reason or motive to participate. If a business elects to not sponsor their own calls, inquiries for their business may be sponsored by local, competing firms which are sponsoring their calls and/or sponsoring competitive calls.

No advertising production costs are required for a business to participate.

The business has an incentive to commence participating promptly: every inquiry for your business you have not sponsored is told of a competing or associative business, that may be sponsoring their calls.

Calls for sponsoring businesses are connected to the sponsoring businesses. Calls for non-sponsoring business are connected to the sponsor but may be connected to the requested business, or both, or a choice between the two is offered.

The system preferably features a call presentation process whereby parties called by the system on behalf of callers are informed of the service by a different ring tone or the like.

Process

1. Requestors ask for the listings they desire.

2. A sponsor is selected (Sponsor Selected Process).

3. The sponsor may or may not be identified to the requester.

4. The listing information requested is provided to the requestor.

5. The call may or may not be automatically connected to the party referred to by the requested listing.

6. The call may or may not be automatically connected to the sponsoring party.

7. The requestor may cause the system to disconnect a call connected to the party.

Sponsor Selection Process

If the requested listing is for a business, and the business represented by the listing is sponsoring their own inquiries, the sponsor selected is the business represented by the requested listing. For example, if the inquiry is for Marlin Travel in White Rock, and Marlin Travel is sponsoring their inquiries, the sponsor is Marlin Travel and the inquiry is said to be “self-sponsoring”.

If the requested listing is for a business, and the business represented by the listing is not sponsoring their own inquiries, the sponsor selected is a competitive or complimentary business to the business represented by the requested listing which ideally is sponsoring their own inquiries and the inquiry is said to be “non-self-sponsoring”.

Of the businesses eligible to sponsor the inquiry, various evaluations may take place in the sponsor selection process. The locations of the businesses eligible to sponsor the inquiry relative to the business represented by the requested listing is often an important consideration.

For example, if the inquiry is for Marlin Travel in White rock, and Marlin Travel is not sponsoring their inquiries, the sponsor is not Marlin Travel and ideally a business which is relatively close to Marlin Travel, competes with Marlin Travel or provides goods and services related to those for which a customer would desire to do business with Marlin Travel, and which is sponsoring its own inquiries.

If the requested listing is for a residence, the sponsor selection process may evaluate various criteria such as time of day, calling party and any associated or related demographic information, information related to historical use of the service by the caller, characteristics of the called party (i.e., out of province/state) to select an appropriate sponsor and the call is said to be a “residential sponsoring”.

For example, if the inquiry is for the residence of Mr. Jones and the calling party is identified as a residence, say Mr. Smith, and Mr. Smith lives in an apartment downtown, and it is Friday at 5 pm, the selected sponsor might be for a Pizza, Night Club, or Movie Rental business.

Example—Self-Sponsoring Call

| | |
|---|---|
| Branding: | “Welcome to FREE-411. Your fast, friendly and |
| | free directory assistance service.” |
| Location | “For what city please?” |
| Solicitation: | |
| Location input: | “White Rock” |
| Name Solicitation: | “For what name please?” |
| Name Input: | “Marlin Travel” |
| Process Message: | “One moment please while an operator looks |
| | for that number” |
| Advertising Message: | “American Express Traveller's Cheques. |
| | Don't leave home without them” |
| Sponsor | “Your call is sponsored by Marlin Travel” |
| Identification: | |
| Sponsor Self- | “Thank you for doing business with us.” |
| Sponsored Buy-Line: | |
| Requested | “The number you requested for Marlin Travel |
| Information | is 604-555-1212.” |
| Delivery: | |
| Call Completion: | “One moment, connecting your call to |
| | Marlin Travel.” |

Example—Non-Self-Sponsoring Call, Competitive Completion

| | |
|---|---|
| Branding: | “Welcome to FREE-411. Your fast, friendly and |
| | free directory assistance service.” |
| Location | “For what city please?” |
| Solicitation: | |
| Location Input: | “White Rock” |
| Name Solicitation: | “For what name please?” |
| Name Input: | “Marlin Travel” |
| Process Message: | “One moment please while an operator looks for |
| | that number” |
| Advertising Message: | “American Express Traveller's Cheques. |
| | Don't leave home without them” |
| Sponsor | “Your call is sponsored by White Rock Travel” |
| Identification: | |
| Sponsor Self- | “Exclusive travel deals. Check us out.” |
| Sponsored Buy-Line: | |
| Requested | “The number you requested for Marlin Travel |
| Information | is 604-555-1212.” |
| Delivery: | |
| (Call Completion): | “Stay on the line and your call will be |
| | connected to your sponsor, White Rock Travel.” |

Example—Non-Self-Sponsoring Call, Selected Completion

| | |
|---|---|
| Branding: | “Welcome to FREE-411. Your fast, friendly and |
| | free directory assistance service.” |
| Location | “For what city please?” |
| Solicitation: | |
| Location Input: | “White Rock” |
| Name Solicitation: | “For what name please?” |
| Name Input: | “Marlin Travel” |
| Process Message: | “One moment please while an operator looks for |
| | that number” |
| Advertising Message: | “American Express Traveller's Cheques. |
| | Don't leave home without them” |
| Sponsor | “Your call is sponsored by White Rock Travel” |
| Identification: | |
| Sponsor Self- | “Exclusive travel deals. Check us out.” |
| Sponsored Buy-Line: | |
| Requested | “The number you requested for Marlin Travel |
| Information | is 604-555-1212.” |
| Delivery: | |
| Call Completion | “Would you like your call to connect to Marlin |
| Solicitation: | Travel or your sponsor, White Rock Travel?” |
| Selection: | “White Rock Travel” |
| (Call Completion): | “Connecting your call to White Rock Travel.” |

Return to Service Reminder

When the other party hangs up, or the requester says “Service Please”, he or she may have their call connected to Marlin Travel or return to the service.

Example—Non-Self-Sponsoring Call, Inquired Completion

| | |
|---|---|
| Branding: | “Welcome to FREE-411. Your fast, friendly and |
| | free directory assistance service.” |
| Location | “For what city please?” |
| Solicitation: | |
| Location input: | “White Rock” |
| Name Solicitation: | “For what name please?” |
| Name Input: | “Marlin Travel” |
| Process Message: | “One moment please while an operator looks for |
| | that number” |
| Advertising Message: | “American Express Traveller's Cheques. |
| | Don't leave home without them” |
| Sponsor | “Your call is sponsored by Baldwin Insurance.” |
| Identification: | |
| Sponsor Self- | “Your call's on us. See us for your travel |
| Sponsored Buy-Line: | insurance.” |
| Requested | “The number you requested for Marlin Travel |
| Information | is 604-555-1212.” |
| Delivery: | |
| (Call Completion): | “One moment, connecting your call to Marlin |
| | Travel, courtesy of Baldwin Insurance.” |

(Return to Service Reminder)

When the call is complete or the requestor says “Service Please”, he or she may have their call connected to the sponsor or return to the service.

Example—Called Party Service Identification

Called Party Service Identification: “Free-411 Calling. We have a customer on the line for you”

Example—Called Party Service Identification, Billing Solicitation

| | |
|---|---|
| Called Party | “Free-411 Calling. We have a customer on |
| Service Identification: | the line for you” |
| Called Party | “Will you accept the charges associated |
| Billing Solicitation: | with this call completion?” |

Service Implementation

The service is best embodied as a directory assistance service or a “Talking Yellow Pages” type of service. A user calls a specified number to obtain directory assistance or the Talking Yellow Pages type of service (to obtain business information by name or classification, and residential information). Other forms of user interaction may also be appropriate, such as wireless PDA or combinations of voice and visual interaction. The call is answered, typically at a call center, or in the case of another implementation of the service, by a hosting service or other such facility.

The service is branded as a free directory assistance service or as offering a free directory assistance type of service. This should not be confused with services which make similar claims but do not actually provide the listing information requested—these are often sponsored referral type services.

In a directory assistance service, a requestor obtains information “by name” (also known as “named lookups”; e.g.: “White Rock Travel”). In a Talking Yellow Pages type of service, a requestor obtains information “by classification” (also known as “class lookups”; e.g. “travel agents”). In the preferred embodiment, both named and class lookups are provided. In the preferred embodiment, the service is provided for free.

Interface

The preferred embodiment of the service is voice and/or visually based. For example, the input from the requester may be from a pen-based computing device, a computer (optionally with voice input), a telephone, etc. The service interacts and provides information to the requestor using available and preferred interface element. Output from the service may be voice and visual (e.g. in the form of maps).

In an embodiment of the invention, the business interface to the system can be entirely web driven such that the business can purchase subscriptions, advertisements, and/or sponsorships, edit and provide advertisements, configure voice mail, configure call routing options, specify hours, and review statistics and other information about calls received from the service.

In a preferred embodiment when a business has subscribed or purchased an advertisement, and provided a phone number to be used for connection purposes, the system will then call the number before activating the subscription or advertisement to ensure it is a working number.

Location

Input to the service may include GPS location information, commonly called “Cell ID” information, and such other information (such as a location reference from the requestor) which provides a notion of geographic location of the user.

Service Location

The service may be embodied as a telephone service, such as a call center with call processing equipment, or may be embodied as machine interpreted code executed in whole or in part on a requestor's device, or both. For example, the service may be implemented as a web site; as a phone service; or as an application for use on a personal computer, portable computer, PDA or mobile phone; in a vehicle, etc.

Process

In an embodiment of the invention, an incoming call is answered at a processing facility, such as a call center.

The information for the inquiry is obtained. The information usually required is (1) the city or town of interest (location information), and (2) the name or classification/type of the business or the name of a residential listing (name or class information), together with the inquiry.

Depending on the properties of the phone being used, location information may be available directly or indirectly. For example, some mobile operators or device operators have facilities for obtaining the geographic location or approximate geographic location of the caller or user which may be used to satisfy the location information. The location information may also be implied by the caller's phone number. Location information may also be stored in the service as a preference associated with the caller. The service may ask the caller for the location or to use a location other than the inferred location.

The inquiry is processed. In the preferred embodiment an automation process is attempted to satisfy the inquiry. Processing of the inquiry does not require an automation process, however, the cost of providing the service is reduced substantially when automation is used. In common practice, users of directory assistance are assessed a charge for usage of the service. This charge effectively pays for the operator who performs the lookup on behalf of the requestor. According to the invention, the use of automation reduces the overall costs such that alternate revenue channels can be effectively employed.

When an automated process is used, in a preferred embodiment, the results are offered to the requestor for confirmation. If the offered results are declined by the user, an operator backup is typically used or the automation process is re-performed excluding the declined candidate.

If an operator is required to satisfy the request the requestor and the operator are connected. The operator uses a database and interacts with the requestor as required to satisfy the request. When completed, the operator informs the system of the desired listing and releases the caller to the system. The operator is then disconnected.

Whether the listing desired was obtained via an automation process or an operator, the system examines the listing and a sponsor is selected.

The sponsor is presented to the requester, the requested information provided, and the call is completed to either the sponsor or the requested listing or the choice is offered to the requester. The service may elect to not perform call completion.

When call completion is performed, the system may introduce itself to the called party. This provides a unique marketing advantage allow business to know that the call was serviced through the system.

The service may remain on the line and use speech recognition to listen to the caller. The speech recognition listens for a command to terminate the call with the called party and return to the system or call another business. The speech recognition may listen for commands such as to bring in a third party to conference into an existing call.

Sending Location and Listing Information to Operator

Another feature that may be used in DA systems is that when utterances are “whispered” to the operator (rather than handled by the ASR system entirely), additional information may be provided to the operator, other than just the utterance. Utterances are whispered to the operator when the ASR system fails to provide a response or a response that meets a minimum level of confidence.

Such a situation occurs after the ASR system determines a “place interpretation” when processing an utterance. For example words like “on”, “near”, “at” or “in” can trigger the ASR system to search a grammar of place names. The result can be returned to the operator with the whisper of the utterance. Preferably candidate listings (even if at a low confidence level) are provided as well. Alternatively, other information can be provided such as language, inquiry type, etc.

The returned listings and other information are sent to the operator's workstation. The operator's workstation places the location and word and/or candidate information into the appropriate workstation user interface elements (such as fields) that allow the operator to work with the interpreted information.

In an alternative embodiment the place names can be used to locate the listing using the ASR system alone. When geographical information is provided, information about the geographical location of the listing can be used to assist in determining the correct listing.

These extra inputs to the operator make the experience better for the directory assistance user, who may avoid additional questions from the operator. The operator will also be more efficient as he or she will need to spend less time obtaining the correct answer.

Alternate Delivery of Automated Directory Assistance Calls

Besides the directory assistance model commonly used on telephones, as the capability of telephones increases, the information provided to a user can also increase. For example, a listing can be sent to a user's phone or device via text, multimedia or other messaging facility. In the case of text messaging, or SMS (Short Message Service), the listing information may be assembled and sent to the caller's mobile phone number.

Other information that can be sent includes maps, coupons, competing businesses, etc. and may not necessarily be directly related to the particular inquiry. For example in a free directory assistance service model, the user could request a particular listing for a business. If a competitor of that business had paid an appropriate fee to the directory assistance service provider, the user might receive with the requested listing a coupon for use with the competitor on their cell phone or PDA.

Optional or Required Words

In another embodiment of the invention, words in the grammar may be flagged as “optional” or “required” for a particular listing. For example the listings for CIBC Wood Gundy Investments and CIBC Wood Gundy Securities are very similar. In order to differentiate the two listing the words “investments” and “securities” would be required, the other words may be optional and are ignored for comparative purposes.

The Edit Distance

The edit distance is a measure of the similarity of two texts. This “distance” is defined as the number of insertions, deletions, or substitutions required to transform one text into the other.

### EXAMPLE 14

If the first text is “test” and the second, “test”, the edit distance is zero (0), as no insertions, deletions, or substitutions are required to change the first text into the second.

If the first text is “test” and the second, “tent”, the edit distance is one (1), as a single substitution (the third character) is required to transform the first into the second.

There are several other methods for calculating the “edit distance” in the art, however, the Levenshtein method is probably the most common.

Edit distances are used commonly: spell checking, plagiarism detection, speech recognition and spell checking all use edit distances. In fact, in the latter application, spell checking, edit distances are what allows for the spell checker to propose alternatives that may have been intended. ASR systems can use edit distances to improve the results obtained. The ASR results returned by passes through grammars are often “near misses”. As the size and similarity of the contents of a grammar increases, the likelihood of the ASR system to provide accurate results typically diminishes. For example, an ASR system may return the result of “tax” instead of “taxi” or non-standard results such as “aeir” instead of “air”. The application of edit distance to the ASR system helps compensate for these potential problems by transforming the results of the grammar passes into words of either equal or higher “value” for the purposes of the ASR system.

To use edit distances, first all of the distinct words in a given criteria definition, (such as a city), are obtained to form a word list as described in PCT Application No. PCT/CA2003/001948. This word list is “duplicated”, copied or otherwise re-obtained (and will be referred to as the “alternate word list”). Each word in the word list is compared against each word in the alternate word list except itself. In other words, if the word list is “a,b,c”, the alternate word list is identical, and the comparisons would be “a,b”, “a,c”, “b,a”, “b,c”, “c,a”, and “c,b” for a total of number of comparisons of a word list of n words being n multiplied by n−1. The edit distance, using the Levenshtein or some other method, is calculated between the words compared.

Optionally, and preferably, one or more phonetic or linguistic matching algorithms (such as the Double Metaphone Algorithm) is also calculated for both words. Each word, alternate word, the edit distance, any linguistic or phonetic representations of the words, and preferably, the usage frequency of the word and the alternate word are written to a database table. The table below shoes the results of a comparison of a word list of “rock, block, docks, rocks, wok” being compared to the word “rock”.

| | | | The Word's | The Alternate | | The Alternate |
|---|---|---|---|---|---|---|
| | The | | Linguistic | Word's Linguistic | The Word's | Word's Usage |
| The | Alternate | The Edit | or Phonetic | or Phonetic | Usage Count | Count or |
| Word | Word | Distance | Matching Token | Matching Token | or Frequency | Frequency |
| rock | block | 2 | RK | PLK | 24 | 4 |
| rock | docks | 2 | RK | TKS | 24 | 2 |
| rock | rocks | 1 | RK | RKS | 24 | 12 |
| rock | wok | 2 | RK | AK | 24 | 6 |

The frequencies provided are the number of listing in the grammar in which the word appears. For example the word “rock” appears in 24 listings and the word “wok” in six. The matching tokens are short abbreviations that reduce a word into a prescribed number of letters based on their pronunciation.

The results provided by the ASR system during the pass through the word list can be evaluated against the database table to determine words which may be considered for inclusion in the whole subset of words used to extract candidates for subsequent dynamic grammar generation. Constraints may be applied as appropriate to yield a broadening or narrowing of the possible terms to be included by comparing the edit distance and/or the linguistic/phonetic tokens.

For example, if the ASR system returned the word “rock”, a search for all of the terms with an edit distance of 1 would, using the above table, yield only “rocks”. Another example using an input of “rock” and the above illustration would be to obtain only the words which have an edit distance of 2 or less and which have a linguistic/phonetic token end in “K” which would yield the words “block” and “wok”. This system therefore returns words which are about the same length and may rhyme.

The linguistic matching algorithm employed in this example is called a “Double Metaphone Algorithm” although others may be used in replacement of or in addition this algorithm. Alternatively, no linguistic matching at all may be included.

The process may yield a very large number of results (n multiplied by n−1 results for a list of n words). In practical application, it would generally be advisable that only those words bearing a predetermined edit distance (y) or less be recorded in the table; where (y) is the maximum distance of interest. In order words, it may be of little use to record the edit distance of “acme” and “Zimbabwe” as this evaluation is unlikely to be considered in practice.

The use of edit distances as described above facilitates a method for “recovering” from some inaccurate ASR results returned by a word list pass process and in particular assists with plural and singular forms of many words. It also facilitates further flexibility in terms of what the user may say and the resulting matches, and also assists in finding “rhymes with” or other relations between words by adjusting the search criteria related to the input word.

Voice Dialer

The ASR system can be used in conjunction with a voice dialer (as commonly found in cellular phones and the like) on a device. The user can give the device, through its voice dialer instructions to carry out a call. If the voice dialer does not have the listing in its contact directory (which is typically quite small) the utterance is sent to a DA system to determine the contact information.

Location and Time of Day

In a preferred embodiment of the invention, the time of day a call is made can further be used to either provide appropriate advertising for a free directory assistance service, or to provide assistance in preparing a dynamic grammar. As certain services are more likely to be called during the night than during the day, entries for inclusion in the grammar when preparing a dynamic grammar as described in PCT Application No. PCT/CA2003/001948 can be flagged appropriately.

In a similar fashion the source of a call (for example the particular city) can be determined using the phone number from which the user is calling, or information provided by the user (for example the location of the requested listing). This information can be used to assist in validating the results returned and improving the confidence level.

Furthermore, the day of the week can also play a role (for example many businesses are busier on weekends than on weekdays).

Businesses, such as restaurants can call in, or otherwise indicate that they want to promote their facility particularly during a period (such as an evening). For example, if a restaurant were to have a cancellation or a slow night, they may sign on and provide an offer to requestors. The offer may include a digital or audio coupon. Upon purchase, the requestor provides the number and the restaurant confirms with the system the validity of the code provided.

Multiple Passes

If the queue for resolution (i.e. waiting time) of a directory assistance call permits, the utterance can simultaneously be run through the ASR system several times. Optionally, different gain levels can be used for each pass. The results can be used to improve the confidence level of the results returned.

Specialized Grammars

In an alternative embodiment of the invention, pre-compiled specialized grammars may be used. When certain “trigger words” are recognized in an utterance, instead of dynamically generating a grammar, the appropriate pre-compiled grammar is used to determine the listing. Examples of trigger words that may be appropriate include “pizza”, “night club”, “restaurant”, “hotel” or “taxi”. If the ASR system detects these words, a precompiled grammar consisting of the appropriate listings (e.g. all taxi companies in the requested city if the “taxi” trigger word is detected) is used for the pass. These grammars may be referred to as “class grammars”.

If the trigger words are not detected the ASR process is conducted normally and the dynamic grammar is generated normally. In further embodiments, pre-compiled grammars can be generated for names and the like (e.g. all business starting with a particular name).

An advantage of using the precompiled grammars is that certain terms in each listing can be ignored (for example the word “Taxi” would not play a role in the precompiled grammar of taxi listings). This helps the ASR system differentiate the listings as a term similar to them all is not considered.

Transposition

Another method that can be used by the ASR system is that of transposition. It is common that a listing such as “Alberto's Salon for Tanning” be referred to as “Alberto's Tanning Salon”. Accordingly, after the utterance is divided into words, these words can be run through the grammar more than one time, using a different word order each time.

Language

In another feature of the ASR system according to the invention is that it can determine the language spoken by the user, and can route the call to an operator or fluent in that language or a grammar prepared using that language. In this way the service can be used to provide translations to the user.

Sequential Calling

There are occasions when a user prefers to call several businesses in a row, typically to determine what they charge for a particular item or if they have an item in stock. For example, a user looking for a particular plant may be willing to call all of the greeneries within a particular area. The system according to the invention can be modified so that when a request for a type of business is made and a list of those businesses is provided, the user is prompted to connect to the first business on the list, and when that call is finished, by pressing a certain key (for example the “#” key) will return to the list and can call the next business.

In an alternate embodiment, the user could record an utterance, perhaps “Are you willing to sell me a particular product for a price of X?” This utterance is recorded and then sent to each business in that class (for example all of the greeneries). Each greenery then has the option to return the call to obtain the business.

Mixing Classes

Another feature which could be used in a directory assistance service is available when the user is looking for a particular class of goods or services. In such occasions a user may provide they have an interest in more than one class, for example “Chinese or Italian restaurants in the West End”. The ASR system would recognize words such as “or” and “and” as meaning more than one class may be involved. In such classes both classes are used in determining the results of the inquiry.

Supplementary Terms

Certain terms appear commonly in advertisements but rarely in business names. Such terms would include “best”, “fastest”, “best price”. Others add more detail to a business, such as “dim sum” for a Chinese restaurant, or “mobile” for a locksmith. In a preferred embodiment of the invention, these terms may be sold to businesses, such that when these words are determined by the ASR system and the class of businesses is appropriate, they will be returned as results.

Information from flyers and websites may be “scraped” and “scanned” or otherwise input into the system to provide content for a business finder. For example, a local paper with an advertiser promoting an sale of an appliance can be marked for representation as “stores with appliances on sale”, “cheap appliances”, etc. Information from commercial POS (Point of Sale), inventory, reservation systems, etc. may also be incorporated to facilitate the concept of answer specific questions such as “I want the cheapest, the fastest delivery of, the longest warranty, the nearest in stock, the closest cheapest hotel room with a pool, the closest mini-van rental, etc.”

Furthermore, the system is capable of making recommendations to callers based on popularity. For example, based on the number of requests for a particular pizza company, the system can offer a recommendation for the most popular in town.

Purchasing of keywords can be done via sales representatives, online, etc. In a preferred embodiment, they may be acquired through a bidding process.

Recording Calls

The system may also be used to record calls. For example when instructing a cellular phone to call an individual, the instruction could be given as “Call Mike and record”. Once the contact number for Mike is located, the system would record the call when the connection is made.

Call Receipt Control

The system can also be used to control receipt of calls. For example, the push to get process could be used to block calls from unidentified numbers or numbers not listed in the contacts database.

Data Aggregation

The system can record information about requesters (for example geographic information), the requests made, connections made etc. This information allows businesses to quickly determine if the system is providing value.

Single Utterance

In a preferred embodiment of the invention, the requestor will provide sufficient information in a single utterance such that no additional prompts for information will be necessary. For example, if the requestor states “Rogers on 4^{th} in Vancouver”, the ASR system will be able to determine the listing as the location information is also provided. Preferably the ASR system will pass the utterance through both the business and residential grammars and return the result with the highest confidence.

Interactive Voice Advertising

A preferred embodiment of the invention allows a requestor to use voice to decide whether or not to connect directly to an advertiser or sponsor. This can be accomplished by the system posing simple yes/no questions to the requester. Therefore, it should not be necessary for the requestor to enter keys to indicate choices.

Gender Recognition

The system can also recognize the gender of the requestor through analysis of the utterance. This allows for advertisements to be further targeted on the basis of gender. Also call handling can be managed using gender recognition, for example a dating service might route female callers to a different line than male callers. Gender can also be used as a variable in the ASR system to resolve a query. For example, women are more likely to be calling a obstetrician than a man. A business may prefer to receive calls from a certain gender as well. Likewise many retailers target one gender rather than the other and are more likely to be requested listings of such gender. Therefore the gender of the requestor can be used as a bias towards or against certain listings.

Interactive Maps

In alternative embodiments of the invention, besides a phone number, other information can be provided through an information provider. For example maps showing the location of the business associated with the requested listing can be pushed to the user's PDA or cellular phone. Alternatively the user can be prompted to provide his or her location and a map can be pushed showing the route to take from the user to the requested business.

The location determination can be done at the same time the ASR system is determining the requested listing as described in PCT Application No. PCT/CA01/00689. Furthermore the maps can be generated using segments as described therein. In such maps, for example roads can be highlighted to show traffic problems or routes. Likewise street segments can be highlighted to show destinations.

The system can allow the use of interactive maps that react to voice instructions, such as “go north”, “go left”, “enlarge”, “magnify”, “shrink”, and the like. Also street names, intersections, points of interest (such as businesses) and other geographical features can be named, and will then be shown on the map. The device used by the requestor in such a context must be capable of showing the map and could be a PC, a PDA, or a cellular phone.

In these cases, the subject matter of the voice request may be a map and the requestor may talk to the map as a single example of an implementation of interactive maps. Conveying an instruction or query to the map via audio or even touch (using a touch screen) would solicit a visual and/or audio response.

In a preferred embodiment traffic congestion can be determined by the system by calculating the speed of the user (as measured by cellular phone signals or GPS system) relative to the known speed limits of an area.

Another use of the map is to display to subscribers and businesses from where potential customers are calling and what listing they are requesting.

Video

In common practice, and as incorporated into various protocols, a VoIP call may provide both audio and video. In the case of such calls where both audio and video is present, the typical application is video conferencing whereby the video image is that of one of the parties. In other words, the subject matter of the video is people. The addition of a video element does not change the voice aspects of the invention described herein, which is applicable to both audio and video with audio media.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

What is claimed is:

1. A method of providing directory assistance from an information provider, comprising:
(a) obtaining an utterance including a request for an entity from a requester;
(b) passing said utterance through an automated speech recognition system to determine a phone number for said entity;
(c) determining if said entity is a subscriber to the information provider; and
(c.1) if said entity is a subscriber, providing said phone number to said requestor and connecting said requestor to said entity;
(c.2) if said entity is not a subscriber, providing said phone number to said requestor and offering to connect said requestor to a subscriber.

2. The method of claim 1 wherein in step (c.2) said subscriber is in the same business class as said entity.

3. The method of claim 2 wherein in step (c.2) said subscriber is proximate to said entity.

4. The method of claim 3 wherein in step (c.2) a coupon is presented to said requestor for said subscriber prior to provision of said phone number.
